(19) United States
(12) Patent Application Publication
(10) Pub. No.: US 2012/0327943 A1
(43) Pub. Date: Dec. 27, 2012

(54) Media Transmission Over a Data Network

(76) Inventors: Udayan Kanade, Pune (IN); Dimple Kuriakose, Pune (IN); Sandeep Soni, Atlanta, GA (US); Gaurav Kulkarni, Pune (IN); Sumeet Katariya, Madison, WI (US)

(21) Appl. No.: 13/582,436

(22) PCT Filed: Mar. 2, 2011
(86) PCT No.: PCT/IB2011/050895

§ 371 Date: Sep. 3, 2012

(30) Foreign Application Priority Data
Mar. 2, 2010 (IN) 532/MUM/2010

(51) Int. Cl. H04L 12/56

(52) U.S. Cl. 370/400

(57) ABSTRACT

A new approach towards transmitting media across a network is disclosed. In an embodiment, the sender prioritizes the data to be sent from a pool of candidate data, and sends it under some bandwidth constraint. The pool of candidate data reflects the present state of the media, and certain data may be discarded without being sent if it becomes irrelevant to the present state of the media. The receiver sends feedback regarding what data is received by it, which may be used for choosing candidate data, or for prioritizing it.

This patent application claims priority from provisional patent application 532/MUM/2010 titled “Media Transmission Over a Data Network” filed in Mumbai, India on Mar. 2, 2010.

### TECHNICAL FIELD

### Technical Field

The present invention relates to data transmission over a network. More particularly, the invention relates to transmission of media such as video and images over a data network.

### BACKGROUND ART

### Background Art

Means of data transmission over a network are well-known in the art. Such means allow different types of data such as audio, video and images to be sent from one machine on the network to another. The network itself can comprise of various technologies that help in establishing a communication channel between the sender and the receiver of data. The communication channel so formed need not be error free, i.e. there is no guarantee that the data being sent will reach the receiver as it is. In a typical long-distance data network, the data is usually sent in the form of packets and these packets can get lost, duplicated or reordered while in transit.

Network protocols such as TCP/IP handle these issues by keeping track of the packets sent, the packets received and by retransmitting the lost packets. In many media transmission protocols, a new data packet/frame is encoded based on the information available in the previous data packet/frame. Such a scheme of data encoding is called “differential encoding”. In this scheme, if a packet is lost while in transit, the receiver will not be in a position to correctly decode any packets/frames that are received after it. In order to solve this problem, the media transmission protocols periodically include a special data packet/frame, such as an ‘I-frame’, in their data stream. These special data packets/frames act as ‘synchronization points’ since they can be decoded without reference to previous data. Such synchronization points also allow newly arrived receivers to start their decoding process.

### DISCLOSURE OF INVENTION

### Disclosure

### SUMMARY

A new approach towards transmitting media across a network is disclosed. In an embodiment, the sender prioritizes the data to be sent from a pool of candidate data, and sends it under some bandwidth constraint. The pool of candidate data reflects the present state of the media, and certain data may be discarded without being sent if it becomes irrelevant to the present state of the media. The receiver sends feedback regarding what data is received by it, which may be used for choosing candidate data, or for prioritizing it.

The above and other preferred features, including various details of implementation and combination of elements are more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiments and together with the general description given above and the detailed description of the preferred embodiments given below serve to explain and teach the principles of the present invention.

FIG. 1 illustrates a block diagram of an exemplary sender and an exemplary receiver connected over an exemplary network, in an embodiment.

FIG. 2 illustrates the working of an exemplary sender, in an embodiment.

FIG. 3 illustrates the working of an exemplary sender sending video data.

FIG. 4. illustrates the working of an exemplary receiver receiving video data.

FIG. 5. illustrates a block diagram of an exemplary network consisting of multiple senders and receivers.

### DETAILED DESCRIPTION

A new approach towards transmitting media across a network is disclosed. In an embodiment, the sender prioritizes the data to be sent from a pool of candidate data, and sends it under some bandwidth constraint. The pool of candidate data reflects the present state of the media, and certain data may be discarded without being sent if it becomes irrelevant to the present state of the media. The receiver sends feedback regarding what data is received by it, which may be used for choosing candidate data, or for prioritizing it.

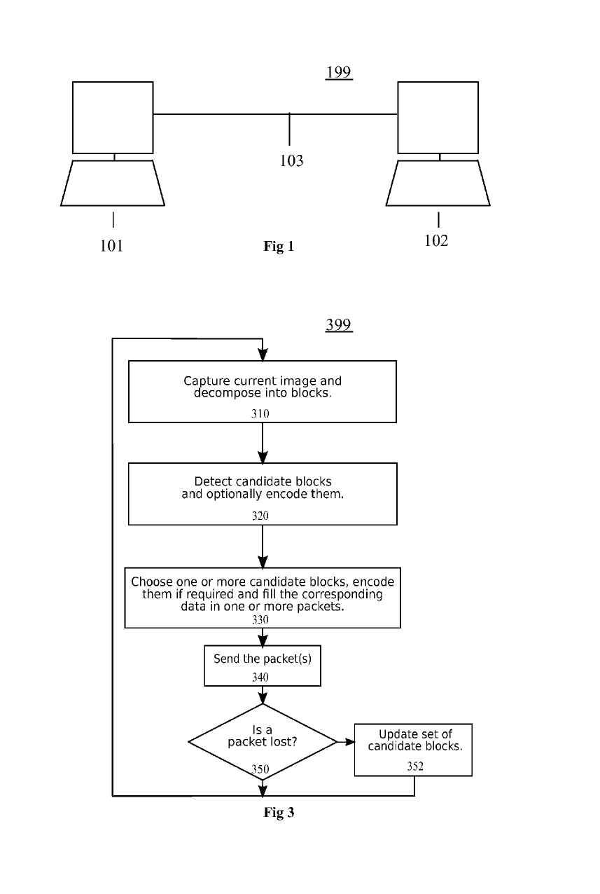

FIG. 1 illustrates a block diagram 199, of an exemplary sender 101 and an exemplary receiver 102 connected over an exemplary network 103, in an embodiment. The sender 101 sends data over the network 103 in the form of data packets. The data could be audio, video, images or any other form of digital data. The network 103 may be a lossy network that drops, duplicates or reorders at least some data packets.

In an embodiment, sender 101 keeps track of the data packets sent to receiver 102, and the data packets received by receiver 102. This helps the sender to determine the packets that are lost and in turn to decide the packets that can be sent next. In order to keep track of the packets, sender 101 maintains the state of each packet and receiver 102 sends an acknowledgement for each packet that it receives. In an embodiment, the receiver 102 could also send an acknowledgement specifically for the data that it received within a packet. The acknowledgement can be transmitted either individually or it can be clubbed together with other pending acknowledgements (for previously received packets/data). In an embodiment, the acknowledgement can also be included as part of a data packet that the receiver is transmitting to the sender; for instance when there is a two-way communication scenario.

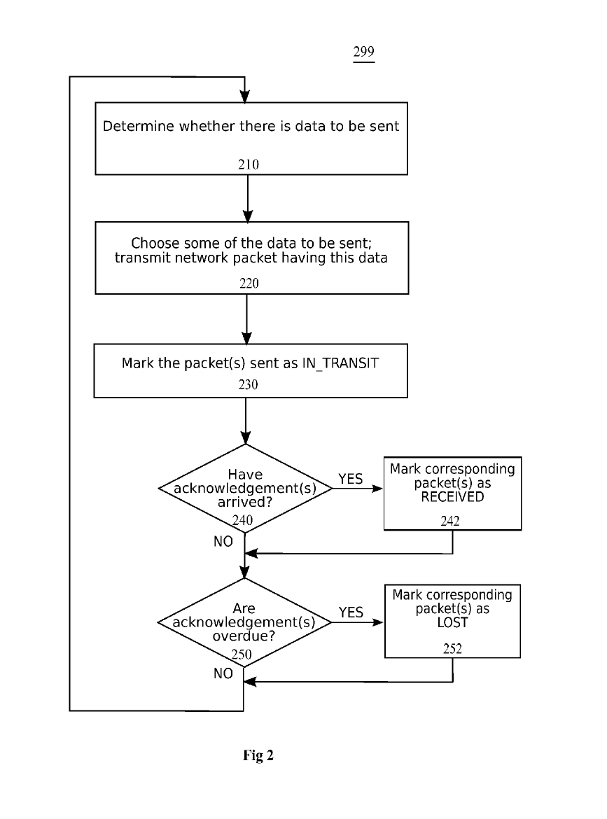

FIG. 2. illustrates the working 299, of an exemplary sender, in an embodiment. The sender determines all the data that may be sent at a given moment (210), and creates one or more network packets having some or all of this data (220). The data to be sent currently, is chosen from all the available possible data that may be sent, using a heuristic which decides the priority of sending various data. The sender transmits these packets over a network to a receiver (220). The sender keeps track of the data it has sent. In an embodiment, this is done by tracking the progress of the data packets over the network. The transmitted packets are marked as IN_TRANSIT (230). (This is marking not on the data packet itself, but in some data structure held by the sender used for tracking sent data packets.) The sender checks whether any acknowledgements from the receiver have arrived (240). If so, the packets for which the acknowledgements have arrived, are marked as RECEIVED (242). The sender checks whether any of the expected acknowledgements are overdue i.e. whether the time required for the acknowledgements to arrive has already been elapsed (250). If so, the packets for which the acknowledgements should have arrived are marked as LOST (252). This set of steps is executed repeatedly until all data to be sent has been successfully transmitted.

In an embodiment, the receiver can report the loss of a packet based on some heuristic. In another embodiment, the sender can detect a packet loss based on some heuristic. In both these cases, the corresponding packet will be marked as LOST.

Whenever a packet or its data is deemed lost, the sender can directly decide to resend that packet or its data. In another embodiment, the sender will resend the lost data only if the lost data is still relevant, i.e. if the object comprising the lost data still needs to be transmitted.

In an embodiment, the sender sends differentially encoded data to the receiver. In an embodiment, the differential encoding is done only based upon RECEIVED data and not based upon IN_TRANSIT data. In this scheme, the receiver may have to remember RECEIVED data beyond its actual use, since it may act as a base for differentially encoded data. In another embodiment, differential encoding may be performed even based upon IN_TRANSIT data. In this case, if some data which is IN_TRANSIT is later considered as LOST, then all the data differentially coded with respect to this data may also be considered lost. In another embodiment, the lost base data may be resent, without regard to whether that is relevant as data to be displayed, since it is relevant as base data for differential encoding. In an embodiment, the amount of differential encoding (or the depth of differential encoding) based on in IN_TRANSIT data is kept limited. In yet another embodiment, differential encoded data is decoded by the receiver even if the data that it is based upon is lost. This will cause decoding errors. Such decoding errors are replicated at the sender, using the knowledge of packet loss, and new data is either differentially or independently encoded with respect to such decoding errors.

Example: Video Transmission

Sender

FIG. 3. illustrates the working 399, of an exemplary sender sending video data. A video stream such as a movie or a computer desktop is captured by the sender as a sequence of images. Each of these images are sent across a network to a receiver in the form of data packets. At the sender, each captured image is decomposed spatially into blocks (310). Amongst the blocks so formed, not all are potential candidates to be sent to the receiver at all times. The ones that have to be sent at any given point in time are called ‘candidate blocks’. In an embodiment, whenever relevant, a partial block can also be considered as a candidate block. In such cases only this partial block may be sent. Once the candidate blocks are determined, they are encoded i.e. compressed to form smaller blocks (320). (The process of encoding can be optionally delayed till the blocks are chosen for transmission.) The data corresponding to these encoded blocks is then filled in one or more packets (330), which are then sent to the receiver (340). In the process of sending, if some of the packets are lost, then the set of candidate blocks is updated accordingly to correctly reflect the data loss.

In an embodiment, a block is marked as a candidate block under the following three circumstances: (1) where the data corresponding to the block i.e. the part of the image corresponding to the block has changed with respect to the data or image sent previously for that block, (2) no data or image has been previously sent for the block and (3) where a block has been sent, but a packet containing the block (or a part of the block), is lost during transmission. In an embodiment, if the lost packet contains only a part of a block, then only that part of the block is marked as a potential candidate. In this scheme a lower level decomposition of a block is needed, e.g a block could be considered as a sequence of bytes.

Once the candidate blocks are determined, their data is compressed. In the case of video or image sequence to be sent, the compression may be performed by any video or image compression technique. The data corresponding to the newest i.e. current version of the block is compressed. If there is an older data/image corresponding to this block, it is now discarded. In another embodiment, such older data is also candidate data to be sent, but this older data has lower priority than the current data to be sent. If the block has not changed, but data corresponding to the block has not been sent yet, the block may be already available in compressed form, in which case the compression is not performed again.

The compressed data of the candidate blocks is then sent in one or more packets. One packet may contain data corresponding to more than one blocks. On the other hand, a single block's data may be split across multiple packets. While a packet is being filled with candidate blocks, there might come a stage when the remaining space is not sufficient to fit the next chosen candidate block completely. In such a case, there are various options available. In an embodiment, the packet is sent without filling the remaining space in the packet. In another embodiment, it is checked to see whether there is a candidate block available that would fit in the remaining space and that block is chosen. In yet another embodiment, or when there are no small enough candidate blocks available, the remaining space in the packet is filled with partial data from the next chosen candidate block. The remaining data from this partially sent candidate block will be sent in the next packet, and the packet after that if necessary, and so forth till all the data from the block is exhausted. Eventually, the data will be exhausted, and there may remain further space in the last packet. This space will be filled based on the candidate choosing algorithms as explained below. In another embodiment, the remaining data from the partially sent candidate block will be treated as candidate data to be sent, and the procedure that chooses which candidate blocks to send will also be presented partially sent candidate blocks, with the partial data remaining being the actual candidate data that is to be sent. During this process of filling multiple packets with data pertaining to a single packet, if the screen image changes, then the process may be aborted. This is because the block's data now pertains to an old image.

Since the data pertaining to all candidate blocks need not fit within a single packet, some of the candidate blocks will have to be given preference over the others. There are multiple options available for specifying this order of choice. In an embodiment, the candidate blocks are chosen in a fixed order, for example, the screen scanning order. In another embodiment, the candidate blocks are chosen according to their encoded (compressed) size. More particularly, the candidate blocks may be chosen in ascending order of their encoded size i.e. more preference is given to smaller blocks. In this scheme, since a packet will contain a maximum amount of screen data, more of the screen changes will be visible sooner at the receiver. (On the other hand, more preference may also be given to larger blocks. In this case, the first changes will be slow, but final changes will be quite fast; and more voluminous information may also reach earlier.) Furthermore, since text images compress better than pictures, this strategy will entail that text often reaches before the picture and the person at the receiver end may start reading before he sees the pictures. Alternatively, the candidate blocks may be chosen according to an estimate of their compressed size. If it is possible to heuristically estimate the compressed size very fast, then candidate selection may be done without running the compression algorithms. This way the compression algorithm has to be run only after the candidate blocks are actually chosen for filling a packet. This can avoid wastage of compression efforts in cases where the block data is changed before the block gets a chance to be sent. In another embodiment, older changes are given preference over newer changes, i.e. the candidate blocks are chosen based on the time (or number of frames of video or number of images in an image sequence) for which they have remained as candidates without being selected for transmission. The blocks with longer times are given preference. This scheme prevents the permanent starvation of some blocks by other blocks. In another embodiment, preference is given to candidate blocks based on how far in the past previous data relating to those blocks (for example a previous image in the same spatial location) has been sent. In this way, data pertaining to all parts of the screen is sent. This is because the scheme prevents the permanent starvation of some blocks that have continuously changing data, by other blocks, that also have changing data. In another embodiment, more preference is given to candidate blocks that have more unsent candidate blocks in their neighborhood. In this scheme, once a block is chosen to be sent, the possibility of its neighbors being sent reduces since the chosen block no longer remains a candidate block. This strategy makes it less likely that large un-updated parts of the screen will prevail since candidate blocks will be chosen from physically diverse locations on the screen. In an embodiment, a combination of two or more of the above strategies are chosen. Each strategy may be implemented as a scoring scheme, and the scores may be combined by addition, by weighted addition, or by more complicated functions. Other candidate block choosing strategies may also be used.

The encoding of candidate blocks can also be done is different ways. In an embodiment, the candidate blocks may be encoded without reference to any previous data. In another embodiment, the candidate blocks can be encoded with reference to some previous data, such as the image data present previously in the same block. For instance, if the difference between the previous block and the current block is only a few pixels, then the difference between the two images may be highly compressed. In another embodiment, the previous data could be from blocks other than the block being encoded. For example this scheme could use the idea of motion compensation and the motion vectors can be separately coded. Thus, in an embodiment, encoding of a block entails a description of the previous data (such as a vector offset in the image explicating where the previous data will be found in the previously encoded image), and a compressed difference between said previous data and the current image. In another embodiment, the candidate blocks may be encoded at a lower resolution to save space in a particular packet. Later on, the higher resolution data may be sent using a differential encoding scheme. In another embodiment, if a large section of the image changes, then adjoining blocks of an image may be encoded together, at a lower resolution.

For differentially encoded blocks, if the previous data (on which the present data depends) is determined to be lost, then the differentially encoded block may also be determined to be lost. Alternatively, the said previous data may be resent, especially if it is cheaper to do so than to send the whole block again without differential encoding.

The encoded candidate blocks are sent to the server in the form of packets. In an embodiment, the packets are numbered at the sender and the packet's number is included in the packet being sent. The numbering is done in such a manner that the correct order of packets is decodable at the receiver. For example, the packets could be numbered consecutively upwards. In an embodiment, the packets are sent by the sender at a particular data rate. For example the data rate could be controlled using the token bucket algorithm. Other rate control algorithms such as different sliding winding protocols are well known in the art and can be used by the sender. The data rate used by the sender may be fixed statically or adaptively based on packet loss statistics.

When a packet is ready to be sent, for example, based on the token bucket algorithm, it is filled with data from the chosen candidate blocks and sent. If a packet is determined to be lost, then in an embodiment, all the blocks present partly or completely in that packet become candidate blocks. In another embodiment, the lost packet may be resent if the data corresponding to the block(s) within that packet is still relevant. On the other hand, if the data is no longer relevant i.e. the image has changed, then the latest data corresponding to those block(s) will be sent. This scheme will ensure that data sent in the packet corresponds to the latest available data for a block. In yet another embodiment, if a particular packet is lost, and it contains partial data pertaining to a block, other parts of which have been received or are expected to be received, and if the actual data pertaining to that block has not changed, then that packet, or at least that particular partial data is retransmitted. This avoids the retransmission of a large encoded block.

Receiver

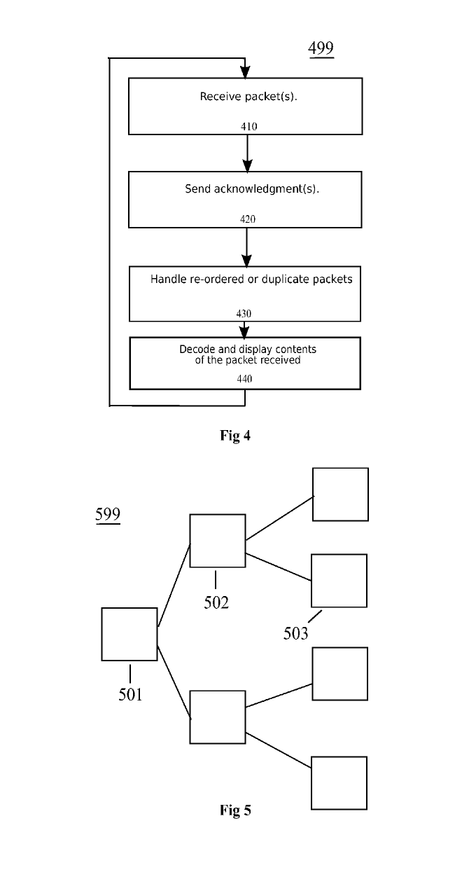

FIG. 4. illustrates the working 499, of an exemplary receiver receiving video data. The receiver receives data packets corresponding to a video stream sent by a sender over a network (410). For each packet received, or for the specific data received within a packet, the receiver sends a corresponding acknowledgement (420). Based on certain information available in each received packet, such as the packet number, the receiver handles packets that have arrived out of order and the packets that are duplicates of previously received packets (430). On receiving an appropriate amount of data, the receiver decodes that data and displays the corresponding contents on screen.

The correct order of packets can be determined from the packet number present in each received packet. If a packet arrives later than its correct queue order, then the contents of that packet may be outdated. This is because newer data could already have arrived in packets that were sent later. In this case, the outdated packet is not used. More specifically, in a particular embodiment, for each block of the image, the packet number due to which the block was last updated is stored. Now if a packet arrives containing data pertaining to a block, then such data is not used to overwrite the existing data when the newly arrived packet has a packet number smaller than the one stored for that block. On the other hand, if later data depends on earlier data, but the earlier data has not yet arrived due to packet reordering, then the later data will be kept in abeyance till the earlier data actually arrives.

In an embodiment, the receiver may actively send information to the sender regarding packets that have not arrived. This may be done by waiting for a certain amount of time, or for a certain number of future packets to be received. This time or the number of future packets to wait for may be decided based on statistics of packet reordering or packet jitter as measured by the receiver.

In another embodiment, the sender requests the receiver to verify that a particular packet, or data identified in a particular way (e.g. data pertaining to an image block captured at a particular instant) has reached the receiver. The receiver may, then, respond with a reply confirming or denying whether it has received said data.

Multi-data-stream Sender

FIG. 5. illustrates a block diagram, 599 of an exemplary network consisting of multiple senders and receivers. It is possible to connect a single sender to many receivers. All the receivers will receive the image/video/media/data sent by the sender. In an embodiment, the sender 502 is a retransmission node, i.e. it receives data from sender 501, and sends it on to multiple receivers 503. Such retransmission nodes may be chained, such that one retransmission node sends data to many nodes, and each such node sends to many more nodes, and so on, till the leaf nodes send data to actual receiver hosts.

In a sender connected to many receivers, the act of actual compression of blocks may be minimized. In one embodiment, every time the image data corresponding to a block changes, the new block is compressed. Such a compressed block may be used as a candidate block in the interaction with various receivers. Corresponding to each such receiver, the sender may have a different set of candidate blocks, based on the data already sent to those receivers, the data received by those receivers, their bandwidth, etc. In another embodiment, every time a block is needed to be compressed, it is checked whether such an action for the present data has already been performed, and if so, the results are used directly, otherwise the compression is performed. In a variation of the above, different data streams i.e. the different data streams corresponding to different receivers, may use different strategies for a given block, such as differential encoding, low resolution encoding, independent encoding, etc. In such a case, each time a particular encoding is performed, it is stored so that similar work need not be performed if requested again.

In an embodiment, where the sender is a retransmission node, such as sender 502, the blocks received from the upstream sender such as sender 501, are already in compressed form. This compressed form of blocks is saved, and used if necessary, so that the corresponding computational load on sender 502 is reduced.

Network Related Details

In an embodiment, the packet structure used by the sender and the receiver is as follows:

Packet
{
packet header
{
packet number ;
packet size;
}
chunk or block
{
chunk or block header;
data;
}
chunk or block
...
...
}

The chunk or block header may comprise of one or more fields of varying bits. The chunk or block header should indicate the length of the chunk or block.

Apart from data pertaining to the media to be transmitted, various control information may also be transmitted in network packets. In an embodiment, such control information may be transmitted if some space in the packet remains which cannot be filled by any of the candidate blocks or if it is determined that filling the candidate block is unfeasible.

In an embodiment, if a sender receives an acknowledgement of a packet sent later whereas the acknowledgement of a packet sent earlier has not yet reached, it can send some control information inquiring about the said earlier packet.

In another embodiment, control information regarding the sequence of blocks that the sender will send next is sent. Alternatively, the information about which blocks have changed is sent before the actual transmission of the changed block. The receiver may use this information to blank out the corresponding blocks in the displayed image, so that old image data does not continue to be seen. The receiver may also use this information to detect early the absence of certain data in the data stream, and send a negative acknowledgement regarding the same to the sender.

In a network characterized by data bursts in delivery of packets, if a certain packet is lost the probability of the packets in the sequence just before and just after the lost packet being lost is more than those that are successively away from this lost packet. Hence, these packets may be transmitted even before it is determined that the packets are really lost.

In order to save space in the packet, encoding related parameters can be exchanged with the receiver before sending the data so that this part of the data is not repeatedly sent again. In another embodiment, header data or part of header data which persists for some time (till the time the block is not changed) can also be exchanged before so that the header data is not repeatedly sent.

In multiple sender transmission, one of the sender or multiple senders can store the data and transmit it further to the remote receiver(s) with some time lag. The sender may also choose different time lags while sending to different receivers. Such a scheme may be useful in utilizing the available bandwidth uniformly.

In the current invention, the data to be sent in the form of packets is sent only after knowing the availability of bandwidth and is not queued beforehand. This ensures that the most recent changes to a block are transmitted without frequent re-transmissions which would occur if the packets were queued. In another embodiment, based on the availability of bandwidth, the sender may choose to send even that data which got updated before it was sent. In case of more than one such updates, few or all such intermediate updates, rather than only the final update, can be sent to the receiver. This scheme will enable smoothness in playback for video transmissions.

In an embodiment, a block can be adaptively considered to be composed of more than one blocks and can be compressed together rather than independently. This gives more compression efficiency. In another embodiment, if it is known that one of the blocks from the composition of blocks is completely received at the receiver, the remaining block or blocks can still be encoded together with the known received block. This can be done repeatedly.

In an embodiment, the data that has already been sent and is in transit may be treated as candidate data. In case that it is known or can be deduced by some method that such in transit data is of very high priority and a lot of future data is dependent on it, then by adopting such a scheme, such a high priority data can be sent quicker, thereby preempting the penalty that can be incurred due to the loss of a packet or an acknowledgment. Also in cases when there is no data that is to be sent such a scheme can be adopted so that the impact of a lost packet or a lost acknowledgment can be minimized.

In an embodiment, the receiver can specify the blocks that the sender should send next. This could be done based on user feedback obtained at the receiver via various methods such as mouse click or other mouse related movement, user gaze detection etc.

A new approach towards transmitting media across a network is disclosed. In an embodiment, the sender prioritizes the data to be sent from a pool of candidate data, and sends it under some bandwidth constraint. The pool of candidate data reflects the present state of the media, and certain data may be discarded without being sent if it becomes irrelevant to the present state of the media. The receiver sends feedback regarding what data is received by it, which may be used for choosing candidate data, or for prioritizing it.

It is understood that the embodiments described herein are for the purpose of elucidation and should not be considered limiting the subject matter of the present patent. Various modifications, uses, substitutions, recombinations, improvements, methods of productions without departing from the scope or spirit of the present invention would be evident to a person skilled in the art.

1. A method comprising:
maintaining a pool of candidate data to be sent,
sending data to a receiver over a data network, and
receiving feedback indicating what data has been received by the receiver.

2. The method of claim 1 further comprising choosing data to send from candidate data using a prioritization method.

3. The method of claim 2, further comprising prioritizing currently relevant data over data pertaining to past times.

4. The method of claim 2, further comprising prioritizing data with smaller size over data with larger size.

5. The method of claim 2, further comprising prioritizing data on which other data depends over data on which no data depends.

6. The method of claim 2, further comprising prioritizing data corresponding to media surrounded by media corresponding to candidate data.

7. The method of claim 2, further comprising prioritizing data which has not been ready but not sent for a long time over data which is ready but has not been sent for a short time.

8. The method of claim 2, further comprising prioritizing data corresponding to media corresponding to data which has not been sent for a long time over data corresponding to media corresponding to data which has not been sent for a short time.

9. The method of claim 2, further comprising a scoring scheme for prioritizing, the scoring scheme taking into account one or more of the size of the data, current relevance, dependency of other data, surrounding media, time period for which the data has not been sent and time period for which no data corresponding to this media has been sent.

10. The method of claim 1 further comprising detecting that certain data has not been received, and reintroducing such data into the pool of candidate data.

11. The method of claim 10 further comprising not reintroducing the data if the data is not presently relevant.

12. The method of claim 1 further comprising removing the data from the pool of candidate data if the media corresponding to the data has changed.
